(19) United States
(12) Patent Application Publication
(10) Pub. No.: US 2023/0415337 A1
(43) Pub. Date: Dec. 28, 2023

(54) GRIP POSITION SETTING METHOD AND ROBOT SYSTEM

(71) Applicant: SEIKO EPSON CORPORATION, Tokyo (JP)

(72) Inventor: Hiroki NAGATA, MATSUMOTO-SHI (JP)

(21) Appl. No.: 18/212,204

(22) Filed: Jun. 21, 2023

(30) Foreign Application Priority Data
Jun. 24, 2022 (JP) 2022-102196

(51) Int. Cl. B25J 9/16; B25J 13/08; B25J 9/00

(52) U.S. Cl. CPC B25J 9/163; B25J 13/085; B25J 9/0096; B25J 9/1664

(57) ABSTRACT

A grip position setting method includes a work step of gripping, by an end effector, an object disposed on a working surface, storing, as a height T1, a height of the end effector when gripping the object, moving the end effector upward to separate the object from the working surface, moving the end effector downward to bring the object into contact with the working surface, storing, as a height T2, a height of the end effector when the object contacts, and acquiring a difference ΔT between the height T1 and the height T2 and a setting step of setting the grip position of the object based on the difference ΔT.

### CROSS-REFERENCE TO RELATED APPLICATIONS

The present application is based on, and claims priority from JP Application Serial Number 2022-102196, filed Jun. 24, 2022, the disclosure of which is hereby incorporated by reference herein in its entirety.

### BACKGROUND

### 1. Technical Field

The present disclosure relates to a grip position setting method and a robot system.

### 2. Prior Art

WO 2018/092254 describes a method for setting a gripping force when gripping a gripping target by a gripper of a robot. Specifically, a deformation amount of the gripping target due to the addition of gripping force is obtained from a first image obtained from imaging the gripping target with a camera in a state in which the gripping force is not added and a second image obtained from imaging the gripping target with the camera in a state in which the gripping force is added, and the gripping force is set based on the obtained deformation amount.

However, WO 2018/092254 does not particularly consider the grip position of the gripping target. For example, it is necessary to set the gripping force higher in the case of gripping a portion away from the centroid of the gripping target than in the case of gripping the vicinity of the centroid. Further, depending on the type of gripping target, the upper limit value of the gripping force may be limited in order to prevent deformation or breakage. Therefore, in WO 2018/092254 in which the grip position of the gripping target is not taken into consideration, the gripping force may be set high, and there is a concern that the gripping of the gripping target may not be appropriately performed.

### SUMMARY

A grip position setting method of the present disclosure is a grip position setting method for a robot system including a robot having an end effector for gripping an object, the grip position setting method being for setting a grip position of the object by the end effector, the grip position setting method including a work step of gripping the object disposed on a working surface by the end effector, storing, as a height T1, a height of the end effector during gripping, moving the end effector upward to separate the object from the working surface, moving the end effector downward to bring the object into contact with the working surface, storing, as a height T2, a height of the end effector at time of contact, and acquiring a difference ΔT between the height T1 and the height T2 and a setting step of setting the grip position of the object based on the difference ΔT.

A robot system of the present disclosure is a robot system including a robot having an end effector for gripping an object wherein the robot system performs the following steps: a work step of gripping the object disposed on a working surface by the end effector, storing, as a height T1, a height of the end effector during gripping, moving the end effector upward to separate the object from the working surface, moving the end effector downward to bring the object into contact with the working surface, storing, as a height T2, a height of the end effector at time of contact, and acquiring a difference ΔT between the height T1 and the height T2 and a setting step of setting the grip position of the object based on the difference ΔT.

### BRIEF DESCRIPTION OF THE DRAWINGS

FIG. 1 is an overall view of a robot system according to a first embodiment.

FIG. 2 is a flowchart for explaining a grip position setting method.

FIG. 3 is a diagram showing a state in which a work is gripped by a robot hand.

FIG. 4 is a diagram showing a state in which the work is lifted.

FIG. 5 is a diagram showing a state in which the work is brought in contact with a working surface.

FIG. 6 is a diagram for explaining an effect obtained by making a trajectory for lifting the work and a trajectory for bringing the work into contact with the working surface the same.

FIG. 7 is a diagram for explaining an effect obtained by making the trajectory for lifting the work and the trajectory for bringing the work into contact with the working surface the same.

FIG. 8 is a diagram showing an example of the grip position of the work in each work step.

FIG. 9 is a flowchart for explaining the grip position setting method according to a second embodiment.

FIG. 10 is a diagram showing moment generated when the work contacts the working surface.

FIG. 11 is a diagram showing a state in which the work is lifted.

FIG. 12 is a diagram showing a grip position in a subsequent work step.

FIG. 13 is a diagram showing a state in which the work is lifted.

FIG. 14 is a diagram showing the grip position in the subsequent work step.

FIG. 15 is a view showing a state in which the workpiece is lifted.

FIG. 16 is a diagram showing the grip position in the subsequent work step.

FIG. 17 is a flowchart for explaining the grip position setting method according to a third embodiment.

FIG. 18 is a diagram showing the grip position of the work in the work step.

FIG. 19 is a diagram showing the grip position of the work in the work step.

FIG. 20 is a diagram showing the grip position of the work in the work step.

FIG. 21 is a diagram showing the grip position of the work in the work step.

FIG. 22 is a diagram showing the grip position of the work in the work step.

FIG. 23 is a diagram showing the grip position of the work in the work step.

FIG. 24 is a flowchart for explaining the grip position setting method according to a fourth embodiment.

### DESCRIPTION OF EMBODIMENTS

Hereinafter, a grip position setting method and a robot system according to the present disclosure will be described in detail based on desirable embodiments shown in the accompanying drawings.

### First Embodiment

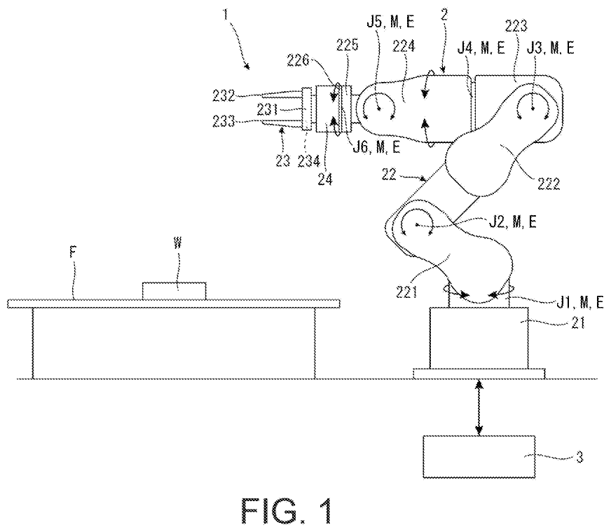

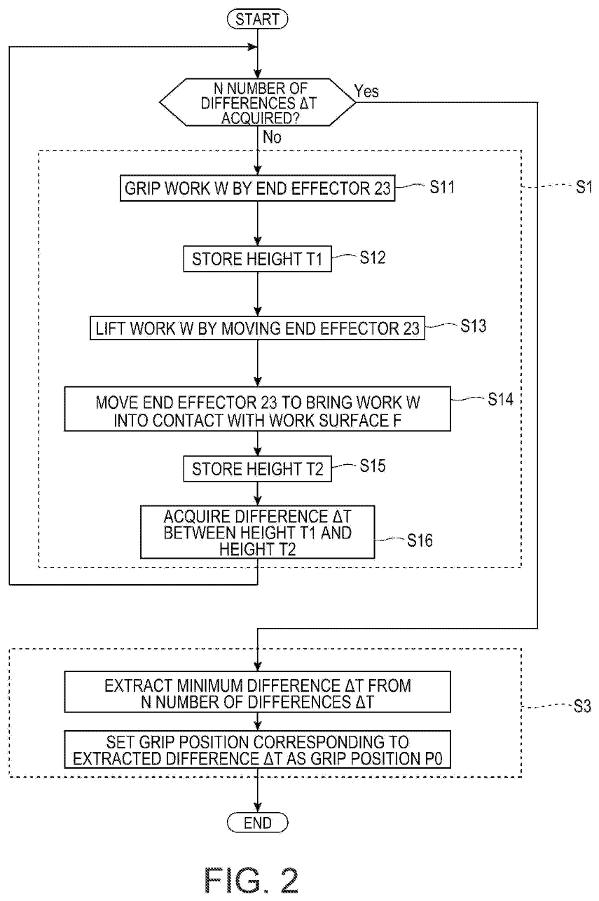

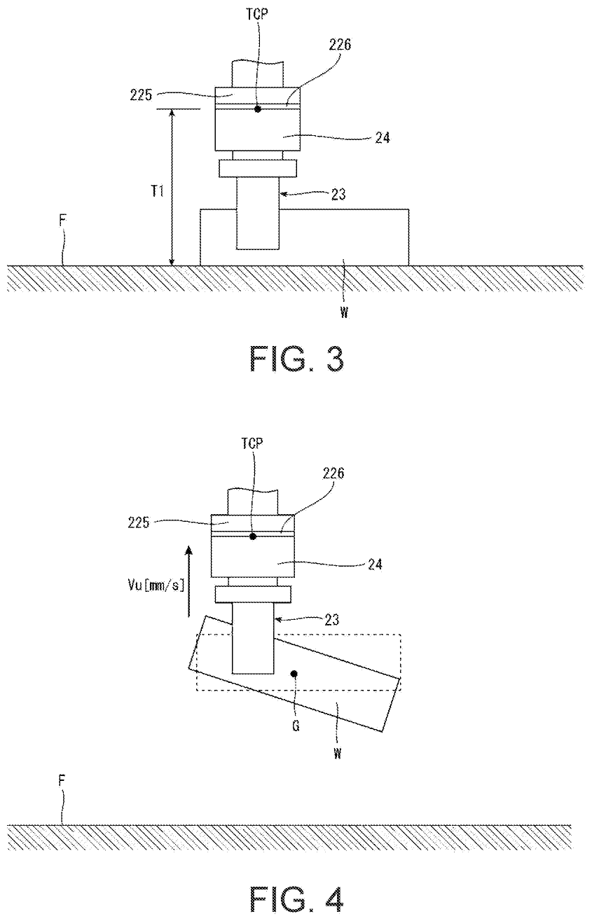

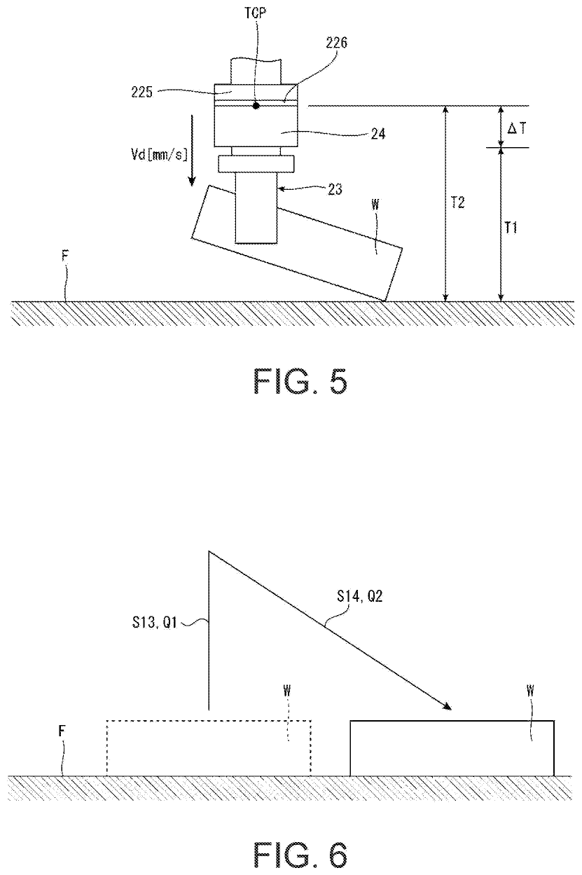

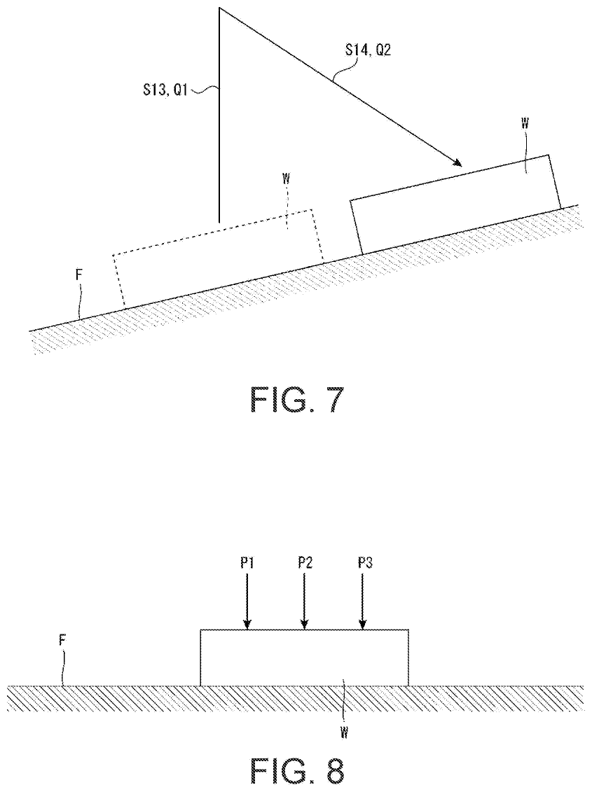

FIG. 1 is an overall view of a robot system according to a first embodiment. FIG. 2 is a flowchart for explaining a grip position setting method. FIG. 3 is a diagram showing a state in which a work is gripped by a robot hand. FIG. 4 is a diagram showing a state in which the work is lifted. FIG. 5 is a diagram showing a state in which the work is brought in contact with a working surface. FIGS. 6 and 7 are diagrams for explaining an effect obtained by making a trajectory for lifting the work and a trajectory for bringing the work into contact with the working surface the same. FIG. 8 is a diagram showing an example of the grip position of the work in each work step. The upper side of each drawing except FIG. 2 is the upper side in the vertical direction, and the lower side thereof is the lower side in the vertical direction.

A robot system 1 shown in FIG. 1 includes a robot 2 that holds a work W as an object, and a control device 3 that controls driving of the robot 2.

The robot 2 is a six axes vertical articulated robot having six drive axes, and includes a base 21, a robot arm 22 rotatably coupled to the base 21, an end effector 23 attached to a tip end of the robot arm 22, and a force sensor 24 attached between the robot arm 22 and the end effector 23. Further, the robot arm 22 is a robotic arm in which a plurality of arms 221, 222, 223, 224, 225, and 226 are rotatably coupled, and includes six joints J1, J2, J3, J4, J5, and J6. Of these six joints J1 to J6, the joints J2, J3, J5 are bending joints and the joints J1, J4, J6 are torsional joints.

A motor M and an encoder E are installed in each of the joints J1, J2, J3, J4, J5, and J6. During the operation of the robot system 1, the control device 3 performs servo control (feedback control) for causing the rotation angles of the joints J1 to J6 indicated by the outputs of the encoders E to coincide with control targets for the joints J1 to J6.

The end effector 23 is configured to grip the work W as the object, and includes a base section 231 connected to the arm 226, a pair of claw sections 232 and 233 coupled to the base section 231 in an openable and closable manner, and a drive mechanism 234 that opens and closes the pair of claw sections 232 and 233. Such an end effector 23 can grip the work W by using the drive mechanism 234 to close the pair of claw sections 232 and 233, and can release the work W by using the drive mechanism 234 to open the pair of claw sections 232 and 233. However, the configuration of the end effector 23 is not particularly limited as long as the end effector 23 can grip the work W.

The force sensor 24 detects a force applied to the end effector 23. Configuration of the force sensor 24 is not particularly limited, but for example, a configuration may be adopted in which the force sensor 24 includes a pressure receiving body formed of quartz crystal, and detects a received force based on a magnitude of an electric charge generated when the pressure receiving body receives the force. The arrangement of the force sensor 24 is not particularly limited as long as the force applied to the end effector 23 can be detected. Further, the force sensor 24 may be omitted.

Although the robot 2 has been described above, the configuration of the robot 2 is not particularly limited. For example, it may be a SCARA robot (horizontal articulated robot), a double-arm robot including two robot arms 22 described above, or the like. Alternatively, it may be a self-propelled robot in which the base 21 is not fixed.

The control device 3 controls driving of the robot 2. The control device 3 is configured by, for example, a computer, and includes a processor (CPU) that processes information, a memory that is communicably connected to the processor, and an external interface that performs connection with an external device. Various programs which can be executed by the processor are stored in the memory, and the processor can read and execute various programs and the like stored in the memory. Some or all of the components of the control device 3 may be disposed inside the housing of the robot 2. Further, the control device 3 may be configured by a plurality of processors.

The configuration of the robot system 1 has been briefly described above. Next, the grip position setting method of the work W performed in the robot system 1 will be described. For example, depending on the position at which the work W is gripped, a difference occurs in the minimum gripping force required for stable lifting. In general, as a position away from the centroid is grasped, the minimum gripping force required for stably lifting tends to increase. That is, it tends to have to be gripped more strongly. Further, depending on the type of the work W, the upper limit value of the gripping force may be limited in order to prevent deformation and breakage. That is, there are also some works W wherein a strong grip is prohibited. Therefore, in the robot system 1, the position where the end effector 23 grips the work W is appropriately set, and it is realized that the work W is stably gripped with the gripping force as small as possible. By this, even a work W with a limited upper limit value for the gripping force can be stably gripped while suppressing deformation and breakage of the work W.

The grip position setting method for the work W is performed before actual work is performed. Then, in the actual work, the work W is gripped at a grip position PD, which is set by the grip position setting method.

As shown in FIG. 2, the grip position setting method performed by the robot system 1 includes a work step S1 and a setting step S3. The work step S1 includes a grip step S11 of grip the work W arranged on a working surface F by the end effector 23, a first storage step S12 of storing, as a height T1, the height of the end effector 23 at the time of gripping, a lifting step S13 of lift the work W by moving the end effector 23 upward, a contact step S14 of bringing the work W into contact with the working surface F by moving the end effector 23 downward, a second storage step S15 of storing, as a height T2, the height of the end effector 23 at the time of contact, and a difference acquisition step S16 of acquiring a difference ΔT between the height T1 and the height T2. In the setting step S3, the grip position P0 of the work W is set based on the difference ΔT acquired in the work step S1.

In particular, in the present embodiment, N differences ΔT are acquired by repeatedly performing the work step S1 a predetermined number of iterations N while changing the position at which the work W is gripped. Then, in the setting step S3, the grip position of the work W is set based on the plurality of differences ΔT acquired in the work step S1. Each step S1 and S3 will be described in detail below.

### Work Step S1

### Grip Step S11

In the grip step S11, the control device 3 controls driving of the robot 2 to, as shown in FIG. 3, grip the work W disposed on the working surface F by the end effector 23. The gripping force at this time is set in advance, and is set to, for example, the same gripping force as in the actual work, which is an appropriate value at which deformation or breakage of the work W does not occur. Accordingly, since the work W is gripped under the same conditions as in the actual work, the work W can be stably gripped during the actual work. Therefore, the smooth actual work becomes possible.

### First Storage Step S12

In the first storage step S12, the control device 3 stores, as the height T1, the height of the end effector 23 when the work W is gripped in the grip step S11. In the present embodiment, a tool center point (TCP) set at the tip end of the robot arm 22 is used as a reference point indicating the height of the end effector 23, and the Z-axis coordinate (vertical axis coordinate) of the TCP is stored as the height T1. However, the reference point indicating the height of the end effector 23 is not particularly limited, and for example, a point set at the center or the tip end of the end effector 23 may be used.

### Lifting Step S13

In the lifting step S13, the control device 3 controls driving of the robot 2 to, as shown in FIG. 4, lift the work W from the working surface F by moving the end effector 23 upward in the vertical direction by a predetermined distance. That is, the work W is separated from the working surface F. At this time, depending on the relative positional relationship between the grip position of the work W and the centroid G, the work W may not incline with respect to the end effector 23 as indicated by chain line, or the work W may incline with respect to the end effector 23 under its own weight as indicated by solid line. The degree of inclination also changes depending on the relative positional relationship between the grip position of the work W and the centroid G.

### Contact Step S14

In contact step S14, the control device 3 controls the driving of the robot 2, as shown in FIG. 5, to move the end effector 23 downward in the vertical direction and bring the work W into contact with the working surface F. The force applied to the end effector 23 at the time of contact is detected by the force sensor 24. Therefore, the control device 3 detects contact between the working surface F and the work W based on the detection value (output) of the force sensor 24. Thus, contact between the working surface F and the work W can be detected easily and accurately.

Here, it is desirable that a movement speed Vu of the end effector 23 upward in the vertical direction in the lifting step S13 and a movement speed Vd of the end effector 23 downward in the vertical direction in this step S14 have the relationship of Vu>Vd. By increasing the movement speed Vu, the inertia acting on the work W increases, and the work W tends to incline with respect to the end effector 23. Therefore, the difference ΔT tends to be large, and the grip position of the work W can be set more accurately. On the other hand, by reducing the movement speed Vd, impact at the time of contact with the working surface F can be suppressed, and deformation, breakage, and the like of the work W can be effectively suppressed. However, the relationship between the movement speeds Vu and Vd is not particularly limited, and may be Vu s Vd. The movement speeds Vu and Vd can be appropriately set according to the gripping force, the weight and shape of the work W, and the like.

### Second Storage Step S15

In the second storage step S15, the control device 3 stores, as the height T2, the height of the end effector 23 when the work W contacts the working surface F in the contact step S14. As in the first storage step S12, the Z-axis coordinate (vertical axis coordinate) of the TCP when the work W contacts the working surface F is stored as the height T2.

### Difference Acquisition Step S16

In the difference acquisition step S16, the control device 3 acquires a difference ΔT between the height T1 and the height T2 as shown in FIG. 5. Here, as described above, in the lifting step S13, the end effector 23 is moved upward in the vertical direction, and in the contact step S14, the end effector 23 is moved downward in the vertical direction. That is, a trajectory Q1 of the end effector 23 when separating the work W from the working surface F and a trajectory Q2 of the end effector 23 when bringing the work W into contact with the working surface F are the same.

For example, when the trajectories Q1 and Q2 are different, as shown in FIG. 6, if the working surface F is a horizontal surface, the work W will contact the working surface F at the same height as the place where the work W originally existed, and thus the difference ΔT does not shift, but as shown in FIG. 7, when the working surface F is inclined with respect to the horizontal surface, the work W contacts the working surface F at a position higher or lower than the place where the work W originally existed, and thus the difference ΔT becomes inaccurate. On the other hand, when the trajectories Q1 and Q2 are the same, the work W is relocated to the place where the work W originally existed, so that the difference ΔT can be accurately acquired regardless of the inclination of the working surface F.

The work step S1 has been described above in detail. In the present embodiment, N differences ΔT are acquired by repeating such a work step S1 a predetermined number of iterations N while changing the position at which the work W is gripped. As an example, FIG. 8 shows grip positions P1 (grip position in the first work step S1), P2 (grip position in the second work step S1), and P3 (grip position in the third work step S1) when N=3. The grip position of each iteration is set in advance before starting the work step S1.

The grip position of the work W for each iteration is not particularly limited, but for example, when the centroid G of the work W is specified by input from a user, CAD data of the work W, or the like, it is desirable to set the vicinity of the centroid G of the work W as the center. In addition, when the centroid G of the work W is unknown but the shape of the work W is specified, it is also desirable to set the vicinity of the center of the work W as the center. In general, it is possible to stably lift the work W with a smaller gripping force by gripping the vicinity of the centroid or the vicinity of the center of the work W. Therefore, by setting the grip position of each iteration centering on such a portion, the possibility of specifying the grip position at which the work W can be gripped more stably is increased. However, the grip position each iteration is not particularly limited.

### Setting Step S3

In the setting step S3, the grip position of the work W is set based on the N differences ΔT obtained in the N iterations of work step S1. Specifically, the smallest difference ΔT is extracted from the N differences ΔT, and the grip position at the iteration when the extracted difference ΔT was obtained is set as the grip position P0 of the work W. That is, the grip position during the iteration when the inclination (posture change) of the work W when lifted was the smallest is determined as the grip position P0 of the work W. Thus, in the actual work, the work W can be stably gripped with an appropriate gripping force that does not cause deformation or breakage of the work W. Therefore, the actual work can be smoothly performed. In particular, in this embodiment, since the most desirable grip position is selected from the N grip positions, the above described effect becomes remarkable, and it becomes easy to set an appropriate grip position.

However, the method of determining the grip position is not particularly limited. For example, a tolerance value (threshold) of the difference ΔT is set in advance, and first, the differences ΔT within the tolerance value are extracted from the N differences ΔT. When there is one extracted difference ΔT, the grip position at the iteration when the difference ΔT was obtained is determined as the grip position of the work W. On the other hand, when there are a plurality of extracted differences ΔT, the grip position at the iteration when one difference ΔT arbitrarily selected from them is obtained is determined as the grip position of the work W. Such a method can also obtain the same effects as the present embodiment.

The robot system 1 has been described above in detail. The grip position setting method performed by the robot system 1 includes the grip position setting method for setting the grip position of the work W by the end effector 23 in the robot system 1 including the robot 2 having the end effector 23 for gripping the work W as the object includes the work step S1 of gripping, using the end effector 23, the work W disposed on the working surface F, storing, as the height T1, the height of the end effector 23 when gripped, moving the end effector 23 upward to separate the work W from the working surface F, moving the end effector 23 downward to bring the work W into contact with the working surface F, storing, as the height T2, the height of the end effector 23 when contacted, and acquiring the difference ΔT between the height T1 and the height T2 and the setting step S3 of setting the grip position P0 of the work W based on the difference ΔT. According to such a method, in the robot system 1, the grip position P0 of the work W can be set appropriately, and the work W can be stably gripped with a gripping force as small as possible. By this, even a work W with a limited upper limit value for the gripping force can be stably gripped while suppressing deformation and breakage of the work W.

Further, as described above, in the grip position setting method, the work step S1 is repeated the predetermined number of iterations N while changing the position at which the end effector 23 grips the work W. This makes it possible to select the most desirable grip position from among the N grip positions. Therefore, it is easy to set an appropriate grip position P0.

As described above, in the setting step S3, the position at which the end effector 23 grips the work W in the work step S1 corresponding to the smallest difference ΔT is set as the grip position P0. Accordingly, it is possible to set the grip position P0 at which the work W can be gripped more stably.

As described above, in the grip position setting method, the contact between the work W and the working surface F is judged based on the detection value of the force sensor 24 disposed in the robot 2. Thus, contact between the working surface F and the work W can be detected easily and accurately.

In addition, as described above, the trajectory Q1 of the end effector 23 when separating the work W from the working surface F is the same as the trajectory Q2 of the end effector 23 when bringing the work W into contact with the working surface F. As a result, since the work W can be relocated at the place where the work W originally existed, the difference ΔT can be accurately acquired. Therefore, the grip position P0 of the work W can be set with high accuracy.

As described above, the movement speed Vu of the end effector 23 when the work W is separated from the working surface F is greater than the movement speed Vd of the end effector 23 when the work W is brought into contact with the working surface F. As described above, by increasing the movement speed Vu, the inertia acting on the work W increases, and the work W tends to incline with respect to the end effector 23. Therefore, the difference ΔT becomes large, and the grip position P0 of the work W can be set more accurately. On the other hand, by reducing the movement speed Vd, impact at the time of contact with the working surface F can be suppressed, and deformation, breakage, and the like of the work W can be effectively suppressed.

As described above, the robot system 1 is a robot system including the robot 2 having the end effector 23 that grips the work W, and executes the work step S1 of gripping the work W disposed on the working surface F by the end effector 23, storing, as the height T1, the height of the end effector 23 when gripped, moving the end effector 23 upward to separate the work W from the working surface F, moving the end effector 23 downward to bring the work W into contact with the working surface F, storing, as the height T2, the height of the end effector 23 at time of contact, and acquiring the difference ΔT between the height T1 and the height T2 and a setting step S3 of setting the grip position P0 of the work W based on the difference ΔT. According to such a method, in the robot system 1, it is possible to appropriately set a position at which the work W is gripped, and to stably grip the work W with a gripping force as small as possible. By this, even a work W with a limited upper limit value for the gripping force can be stably gripped while suppressing deformation and breakage of the work W.

### Second Embodiment

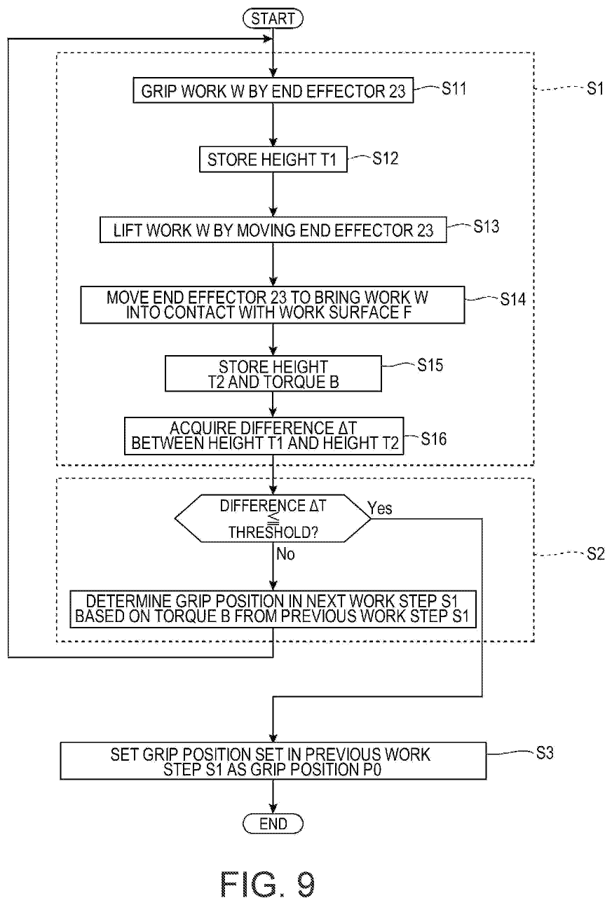

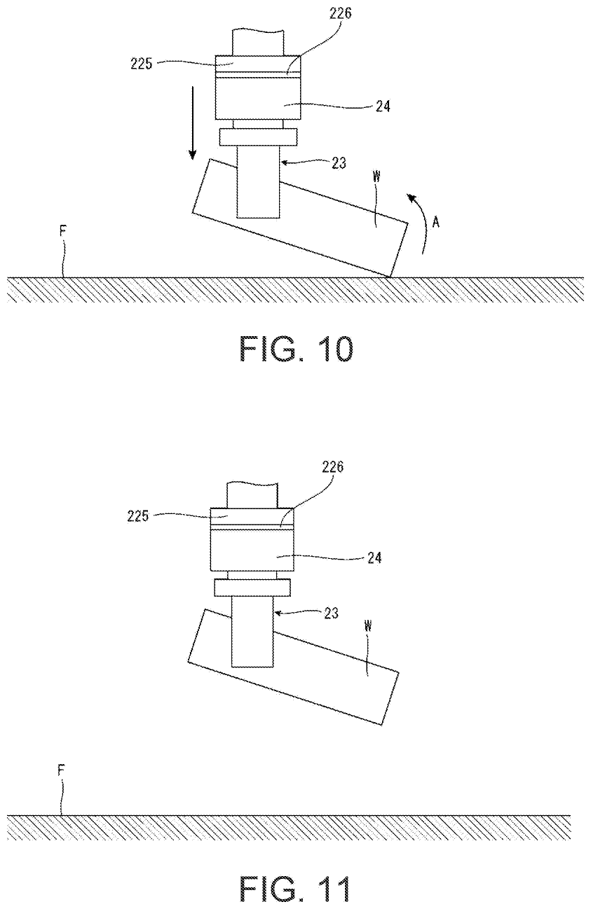

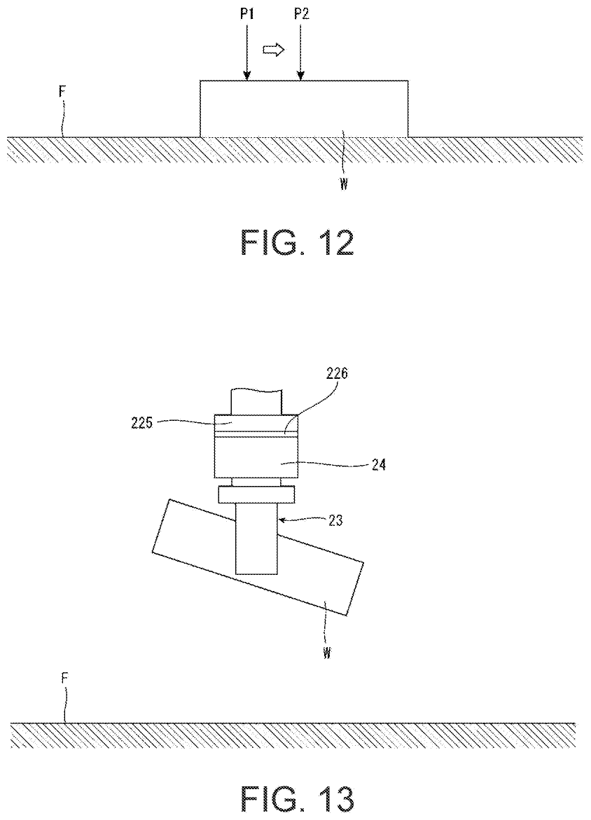

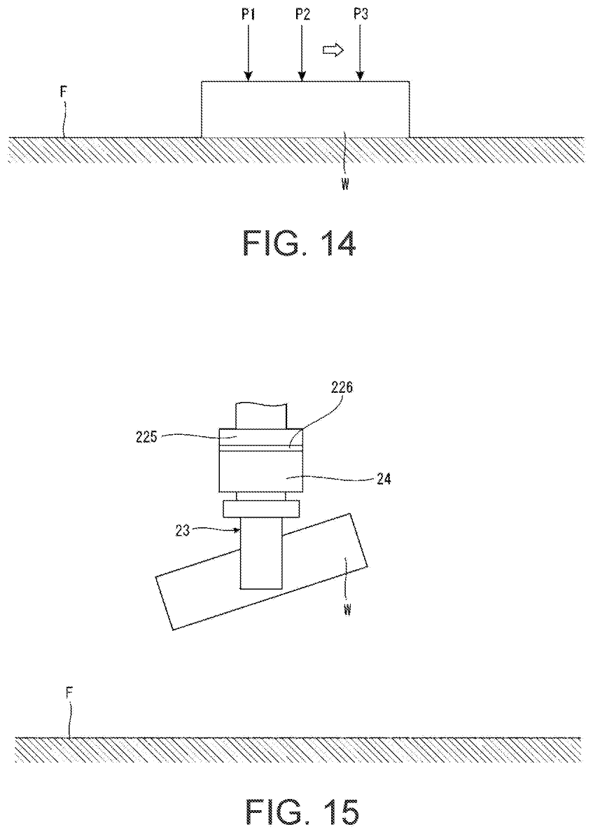

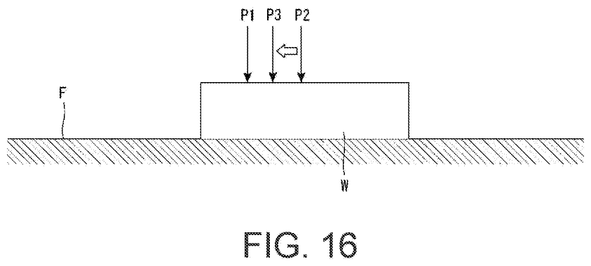

FIG. 9 is a flowchart for explaining the grip position setting method according to a second embodiment. FIG. 10 is a diagram showing moment generated when the work contacts the working surface. FIG. 11 is a diagram showing a state in which the work is lifted. FIG. 12 is a diagram showing a grip position in a subsequent work step. FIG. 13 is a diagram showing a state in which the work is lifted. FIG. 14 is a diagram showing the grip position in the subsequent work step. FIG. 15 is a view showing a state in which the workpiece is lifted. FIG. 16 is a diagram showing the grip position in the subsequent work step.

The robot system 1 of the present embodiment is the same as the robot system 1 of the above described first embodiment except that the grip position setting method is different. Therefore, in the following description, the present embodiment will be described with a focus on differences from the first embodiment described above, and description of similar matters will be omitted. In the drawings of the present embodiment, the same components as those of the above described embodiment are denoted by the same reference symbols.

In the grip position setting method of the first embodiment described above, the position at which the work W is gripped in each work step S1 is set in advance, but in the grip position setting method of the present embodiment, only the position at which the work W is gripped in the initial iteration of work step S1 is set in advance, and the position at which the work W is gripped in subsequent work step S1 is determined based on torque B detected in the previous work step S1. Hereinafter, the grip position setting method according to the present embodiment will be described in detail based on a flowchart shown in FIG. 9.

As shown in FIG. 9, the grip position setting method of the present embodiment includes a work step S1, a subsequent iteration grip position determining step S2, and a setting step S3. In the present embodiment, the work step S1 is configured to be repeated while changing the position at which the work W is gripped until the difference ΔT acquired in the work step S1 becomes equal to or less than a preset threshold.

### Work Step S1

### Grip Step S11 to Contact Step S14

The grip step S11 to the contact step S14 are the same as in the first embodiment described above. Therefore, the description is omitted.

### Second Storage Step S15

In the second storage step S15, the control device 3 stores, as the height T2, the height of the end effector 23 when the work W contacts the working surface F in the contact step S14. Further, the control device 3 stores the torque B applied to the end effector 23 when the work W contacts the working surface F in the contact step S14. For example, as shown in FIG. 10, when the work W in contact with the working surface F in an inclined state with respect to the end effector 23, a force A (moment) for rotating the work W is generated, and the torque B is a force applied to the end effector 23 by the force A. Such a torque B can be acquired based on the output value from the force sensor 24.

### Difference Acquisition Step S16

In the difference acquisition step S16, the control device 3 acquires a difference ΔT between the height T1 and the height T2.

### Subsequent Iteration Grip Position Determining Step S2

In the subsequent iteration grip position determining step S2, the control device 3 first determines whether the difference ΔT acquired in the immediately preceding work step S1 is equal to or less than a predetermined threshold. If the difference ΔT is equal to or smaller than the threshold, the control device 3 ends this step S2 and proceeds to the setting step S3.

On the other hand, when the difference ΔT exceeds the threshold, the control device 3 changes the grip position of the work W and performs the work step S1 again. At this time, the control device 3 determines the grip position P2 of the work W in the subsequent (second) iteration of work step P2 based on the torque B acquired in the previous (first) work step S1. Specifically, whether the work W inclines to the left or to the right with respect to the end effector 23 can be detected from the direction of the torque B applied to the end effector 23 when the work W contacts the working surface F in the contact step S14. Therefore, for example, when as shown in FIG. 11, the work W inclines to the right, then as shown in FIG. 12, the grip position P2 of the work W in the subsequent (second) iteration of work step S1 is shifted to the right from the grip position P1 of the work W in the previous (first) iteration of work step S1.

If the difference ΔT acquired in the second iteration of work step S1 also exceeds the threshold, the control device 3 performs the work step S1 again, but the grip position of the work W at that time is determined based on the torque B acquired in the second work step S1. For example, when as shown in FIG. 13, the work W inclines to the right even in the second iteration of work step S1, then as shown in FIG. 14, the grip position P3 of the work W in the subsequent (third) iteration of work step S1 is shifted further to the right from the grip position P2. On the other hand, when as shown in FIG. 15, the work W inclines to the left in the second iteration of work step S1, then as shown in FIG. 16, the grip position P3 of the work W in the subsequent (third) iteration of work step S1 is shifted to the left from the grip position P2 so as to be positioned between the grip position P1 and the grip position P2.

In the third and subsequent iterations of work steps S1, the grip position of the work W in the subsequent iteration of work step S1 may be determined based on the torque B in the previous iteration of work step S1 in the same manner as described above. In this way, by determining the grip position of the work W in the subsequent iteration of work step S1 based on the torque B, which is the detection value of the force sensor 24 at the time of contact between the work W and the working surface F in the previous iteration of work step S1, then the difference ΔT can be reduced as the number of iterations of work steps S1 increases, and the difference ΔT can be made equal to or less than the threshold in a smaller number of iterations. Therefore, the grip position can be set in a shorter time.

### Setting Step S3

In the setting step S3, the previous iteration of work step S1, that is, the grip position in the work step S1 when the difference ΔT becomes equal to or less than the threshold is determined as the grip position P0 of the work W.

As described above, in the grip position setting method of the present embodiment, the work step S1 is repeated while changing the grip position of the work W by the end effector 23 until the difference ΔT becomes equal to or less than the threshold. Therefore, an appropriate grip position P0 of the work W can be set more reliably.

As described above, the position at which the end effector 23 grips the work W is determined based on the detection value, that is, the torque B, of the force sensor 24 at the time of contact between the work W and the working surface F in the previous iteration of work step S1. The difference ΔT can be reduced each time work step S1 is repeated, and the difference ΔT can be made to be less than or equal to the threshold with a smaller number of iterations. Therefore, the grip position can be set in a shorter time.

According to the second embodiment, the same effects as described for the first embodiment can be exhibited.

### Third Embodiment

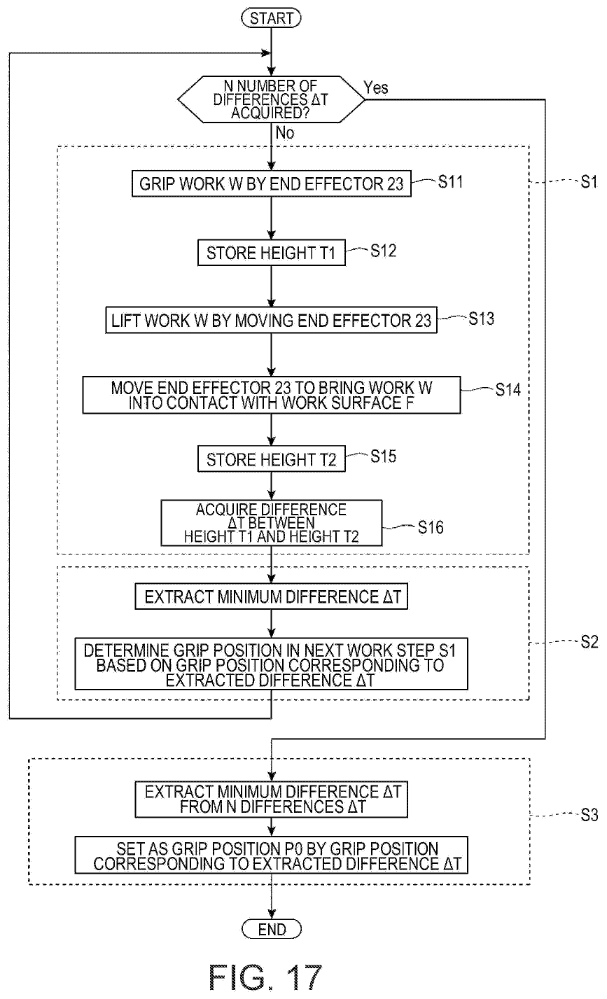

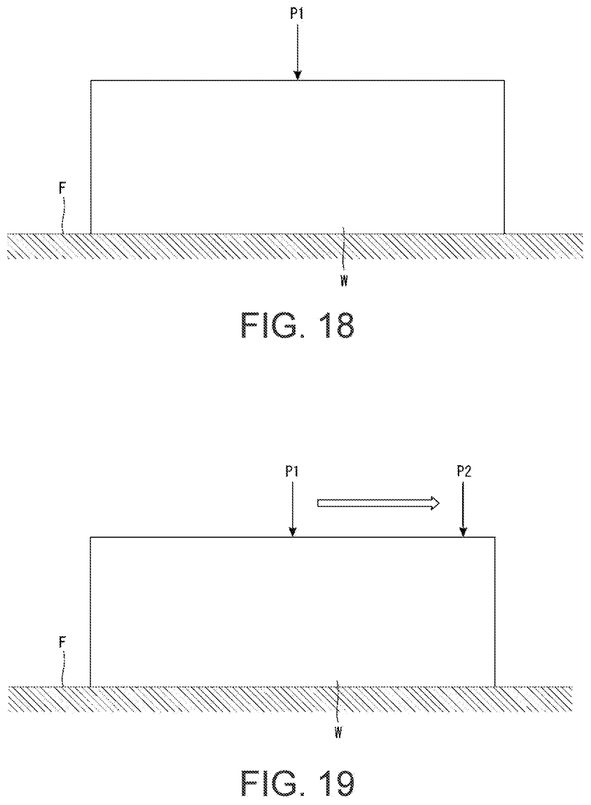

FIG. 17 is a flowchart for explaining the grip position setting method according to a third embodiment. FIGS. 18 to 23 are diagrams showing the grip position of the work in the work step.

The robot system 1 of the present embodiment is the same as the robot system 1 of the above described first embodiment except that the grip position setting method is different. Therefore, in the following description, the present embodiment will be described with a focus on differences from the first embodiment described above, and description of similar matters will be omitted. In the drawings of the present embodiment, the same components as those of the above described embodiment are denoted by the same reference symbols.

In the grip position setting method of the first embodiment described above, the position at which the work W is gripped in each iteration of work step S1 is set in advance, but in the grip position setting method of the present embodiment, only the position at which the work W is gripped in the initial iteration of work step S1 is set in advance, and the position at which the work W is gripped in subsequent work steps S1 is determined based on the differences ΔT obtained so far. Hereinafter, the grip position setting method according to the present embodiment will be described in detail.

As shown in FIG. 17, the grip position setting method of the present embodiment includes a work step S1, a subsequent iteration grip position determining step S2, and a setting step S3. In particular, in the present embodiment, the work step S1 is repeated a predetermined number of iterations N determined in advance while changing the grip position of the work W to acquire N differences ΔT. Then, in the setting step S3, the grip position of the work W is set based on the N differences ΔT acquired in the work step S1.

### Work Step S1

This is the same as in the first embodiment described above. Therefore, the description is omitted. It should be noted that in this embodiment, as shown in FIG. 18, the grip position P1 of the work W in the first iteration of work step S1 is positioned near the center of the work W.

### Subsequent Iteration Grip Position Determining Step S2

In the subsequent iteration grip position determining step S2, the control device 3 first extracts the minimum difference ΔT from the differences ΔT obtained so far. Next, the control device 3 determines the grip position in the subsequent work step S1 based on the grip position corresponding to the extracted minimum difference ΔT. Since only one difference ΔT is acquired in a state where the first iteration of work step S1 is completed, the grip position P2 in the subsequent (second) iteration of work step S1 is determined based on the grip position P1. In the example shown in FIG. 19, the grip position P2 is set at a position shifted to the right from the grip position P1. However, not limited thereto, and the grip position P1 may be set at a position shifted to the left side from the grip position P2.

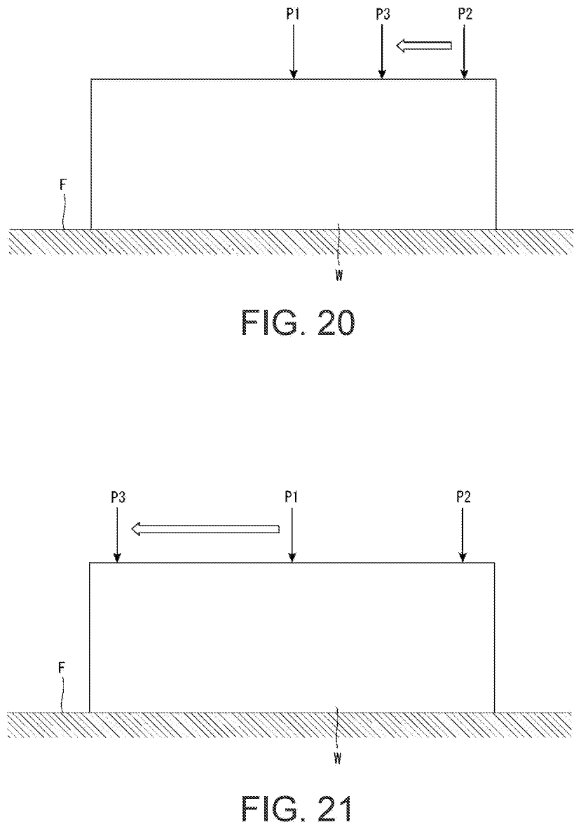

If the difference ΔT in the second iteration of work step S1 is the minimum among the differences ΔT acquired so far, the grip position P3 in the subsequent (third) iteration of work step S1 is determined based on the grip position P2. Specifically, the grip position P3 is set at the position shifted to the right or left from the grip position P2. In the example shown in FIG. 20, the grip position P3 is set at a position displaced to the left from the grip position P2 by a distance shorter than the separation distance between the grip positions P1 and P2. In contrast, when the difference ΔT in the second iteration of work step S1 is not the smallest among the differences ΔT acquired so far, that is, when the difference ΔT in the first iteration of work step S1 is the smallest, the grip position P3 is determined based on the grip position P1. In the example shown in FIG. 21, the grip position P3 is set at a position shifted to the left side (to the opposite side than the grip position P2) from the grip position P1. The description will be continued below using the case of FIG. 21 as an example.

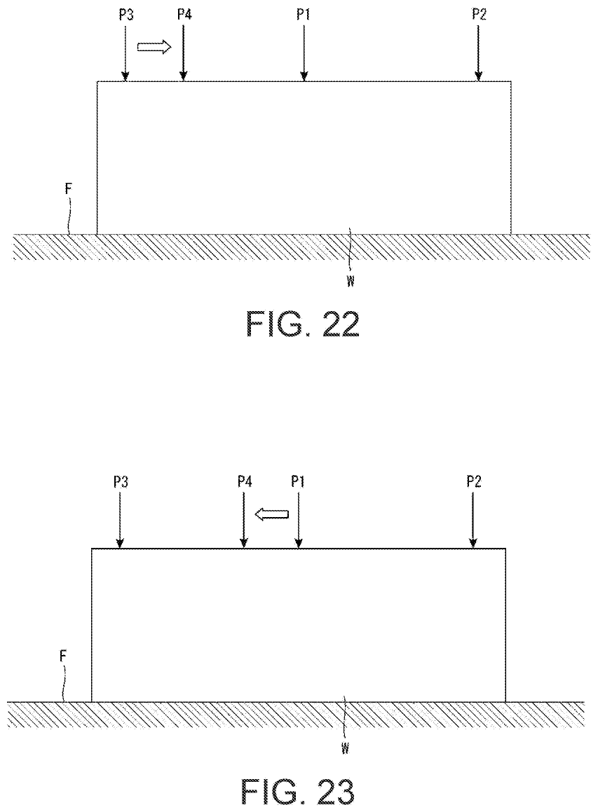

If the difference ΔT in the third iteration of work step S1 is the smallest among the differences ΔT acquired so far, the grip position P4 in the subsequent (fourth) iteration of work step S1 is determined based on the grip position P3. Specifically, the grip position P4 is set at the position shifted to the right or left from the grip position P3. In the example shown in FIG. 22, the grip position P4 is set at a position displaced to the left from the grip position P3 by a distance shorter than the separation distance between the grip positions P1 and P3. In contrast, when the difference ΔT in the third iteration of work step S1 is not the smallest among the differences ΔT acquired so far, that is, when the difference ΔT in the first iteration of work step S1 is the smallest, the grip position P4 is determined based on the grip position P1. Specifically, the grip position P4 is set at the position shifted from the grip position P1 to a side with a smaller difference ΔT, from among the grip positions P2 and P3, which are on both sides of the grip position P1. For example, when the difference ΔT in the third iteration of work step S1 is smaller than that in the second work step, as shown in FIG. 23, the grip position P4 is set at a position shifted to the left side from the grip position P1 by a distance shorter than the separation distance between the grip positions P1 and P3.

As described above, by determining the subsequent grip position based on the grip position in the iteration of work step S1 when the difference ΔT is the minimum among the differences acquired so far, the difference ΔT can be reduced as the number of iterations of the work step S1 increases, and the possibility that a sufficiently small difference ΔT is obtained during the predetermined number of iterations N increases. Therefore, the grip position P0 can be set more appropriately.

### Setting Step S3

In the setting step S3, the grip position of the work W is set based on the N differences ΔT obtained in the N iterations of work step S1. Specifically, the smallest difference ΔT is extracted from the N differences ΔT, and the grip position at the iteration when the extracted difference ΔT was obtained is set as the grip position P0 of the work W.

As described above, in the grip position setting method of the present embodiment, the position at which the end effector 23 grips the work W is changed based on the minimum differences ΔT acquired so far. According to such a method, the difference ΔT can be decreased each time the number of iterations of the work step S1 is increased, and the possibility that a sufficiently small difference ΔT is obtained during the predetermined number of iterations N is increased. Therefore, the grip position P0 can be set more appropriately.

According to the third embodiment as well, the same effects as those described above for the first embodiment can be achieved.

### Fourth Embodiment

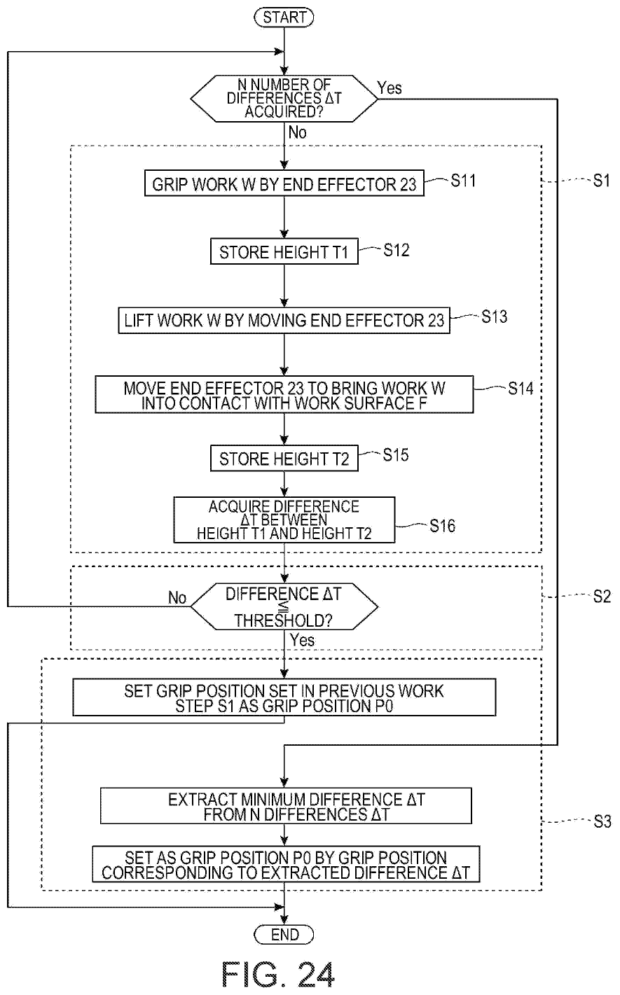

FIG. 24 is a flowchart for explaining the grip position setting method according to a fourth embodiment.

The robot system 1 of the present embodiment is the same as the robot system 1 of the above described first embodiment except that the grip position setting method is different. Therefore, in the following description, the present embodiment will be described with a focus on differences from the first embodiment described above, and description of similar matters will be omitted. In the drawings of the present embodiment, the same components as those of the above described embodiment are denoted by the same reference symbols.

In the grip position setting method according to the present embodiment, the grip position P0 is set by the method in which the above escribed first and second embodiments are combined. That is, the work step S1 is repeatedly performed a predetermined number of iterations N determined in advance while changing the grip position of the work W to acquire the N differences ΔT, but when the difference ΔT becomes equal to or less than the threshold before the N differences ΔT are acquired, the acquisition of the difference ΔT is stopped at that time, and the process proceeds to the setting step S3. According to such a method, if the difference ΔT becomes equal to or less than the threshold before the N-th iteration, it is possible to shift to the setting step S3 at that time, so that the time required to set the grip position P0 can be shortened. On the contrary, by setting the number of iterations of the work step S1 in advance, it is possible to prevent the work step S1 from being performed an excessive number of iterations, and to suppress an excessive extension of the time required to set the grip position P0.

According to the fourth embodiment, the same effects as those of the first embodiment described above can be achieved.

The grip position setting method and the robot system according to the present disclosure have been described above with reference to the shown embodiments, the present disclosure is not limited thereto. In addition, the grip position setting method and the robot system can be replaced with any process capable of exhibiting the same function. Further, the respective embodiments may be appropriately combined.

What is claimed is:

1. A grip position setting method for a robot system including a robot having an end effector for gripping an object, the grip position setting method being for setting a grip position of the object by the end effector, the grip position setting method comprising:
a work step of
gripping the object disposed on a working surface by the end effector,
storing, as a height T1, a height of the end effector during gripping,
moving the end effector upward to separate the object from the working surface,
moving the end effector downward to bring the object into contact with the working surface,
storing, as a height T2, a height of the end effector at time of contact, and
acquiring a difference ΔT between the height T1 and the height T2 and
a setting step of setting the grip position of the object based on the difference ΔT.

2. The grip position setting method according to claim 1, wherein
the work step is repeated a predetermined number of iterations while changing position at which the end effector grips the object.

3. The grip position setting method according to claim 2, wherein
in the setting step, the position at which the end effector grips the object in the work step that corresponds to the smallest difference ΔT is set as the grip position.

4. The grip position setting method according to claim 1, wherein
the work step is repeated while changing the grip position of the object by the end effector until the difference ΔT becomes equal to or less than a threshold.

5. The grip position setting method according to claim 2, wherein
the contact between the object and the working surface is judged based on a detection value of a force sensor disposed in the robot.

6. The grip position setting method according to claim 5, wherein
the position at which the end effector grips the object is determined based on the detection value of the force sensor during contact between the object and the working surface in a previous iteration of the work step.

7. The grip position setting method according to claim 2, wherein
the position at which the end effector grips the object is changed based on the smallest of the differences ΔT acquired so far.

8. The grip position setting method according to claim 1, wherein
a trajectory of the end effector when separating the object from the working surface is the same as a trajectory of the end effector when bringing the object into contact with the working surface.

9. The grip position setting method according to claim 1, wherein
a movement speed of the end effector when separating the object from the working surface is greater than a movement speed of the end effector when bringing the object into contact with the working surface.

10. A robot system including a robot having an end effector for gripping an object wherein
the robot system performs the following steps:
a work step of
gripping the object disposed on a working surface by the end effector,
storing, as a height T1, a height of the end effector during gripping,
moving the end effector upward to separate the object from the working surface,
moving the end effector downward to bring the object into contact with the working surface,
storing, as a height T2, a height of the end effector at time of contact, and
acquiring a difference ΔT between the height T1 and the height T2 and
a setting step of setting the grip position of the object based on the difference ΔT.
